(19) United States
(12) Patent Application Publication
(10) Pub. No.: US 2012/0318753 A1
(43) Pub. Date: Dec. 20, 2012

(54) FOOD OIL VACUUM FILTER SYSTEM

(75) Inventor: Kenneth Forrester, South Berwick, ME (US)

(73) Assignee: R.F. Hunter Company, Inc., Dover, NH (US)

(21) Appl. No.: 13/478,437

(22) Filed: May 23, 2012

Related U.S. Application Data
(60) Provisional application No. 61/489,433, filed on May 24, 2011.

(51) Int. Cl. B01D 35/26; B01D 29/96; B01D 39/00; B01D 29/60; B01D 35/00

(52) U.S. Cl. 210/767; 210/406; 210/241; 210/121

(57) ABSTRACT

A vacuum filtration device includes a removable power unit that includes a vacuum pump. The vacuum pump functions in one mode to remove hot oil from a fryer and to draw the oil into a container. The hot oil is fed through a filter located within the container that removes sediment. The filtered oil is then returned to the fryer through a pick-up opening and a hose by turning off the vacuum pump and in place creating a pressure inside the canister. A valve allows for transfer of the hot oil to and from the unit. A hose and nozzle assembly transports the hot oil the vacuum filtration device. The vacuum filtration device is mobile on a cart that may feature wheels and a handle.

### CROSS-REFERENCE TO RELATED APPLICATIONS

This application claims priority from U.S. Provisional Patent Application No. 61/489,433, entitled “Food Oil Vacuum Filter System” filed on May 24, 2011 and incorporated fully herein by reference.

### TECHNICAL FIELD

The present invention relates to a system and device for filtering oil and more particularly, relates to a vacuum filter system for removing debris from cooking oil used in a food fryer appliance.

### BACKGROUND INFORMATION

Cooking oils are used to deep fry foods in deep fryers. These oils can be quite expensive. In order to save money, restaurants clean and reuse the cooking oils. In order to reuse the oil, the oil must be cleaned and filtered in order to remove food particles from the oil and to prevent the oil from going rancid and to ensure that the oil is still safe and usable. Restaurants that use large commercial fryers have large amounts of cooking oil that they need to filter on a regular (typically daily) basis. The current filtering methods and apparatus have often required direct contact with hot oils, which can lead to serious burns. Additionally, some of the current systems allow the hot oil to contact various pumps and gears, which can lead to mechanical failure due to overheating and clogging. Further, many of such prior systems are not mobile.

Accordingly, what is needed is a mobile filter system that can be used for edible cooking oils that is capable of straining sediment and impurities from oils to be reused in the food industry. The device should safely and economically filter contaminated oils from cooking processes without the danger of handling the hot oils directly. The hot oil should not come into contact with any pumps or gears, thereby reducing the occurrence of mechanical failures. Additionally, the device should be a closed system, such that the device will provide for the safe, spill-free transportation of waste oil from a fryer to the filter system and from the filter system back to the fryer.

### BRIEF DESCRIPTION OF THE DRAWINGS

These and other features and advantages of the present invention will be better understood by reading the following detailed description, taken together with the drawings wherein:

FIG. 1 is a prospective view of the vacuum filtration device of one embodiment of the present invention;

FIG. 2 is a cross sectional view of the vacuum filtration device, which details the internal components of the vacuum filtration system as provided in one embodiment of the present invention;

FIG. 3 is a detailed view of the hose and nozzle assembly as provided in one embodiment of the present invention; and

FIG. 4 is an exploded view of the power unit of the present invention with the cover removed and the drum or container removed, as provided in one embodiment of the present invention.

### DETAILED DESCRIPTION OF THE PREFERRED EMBODIMENTS

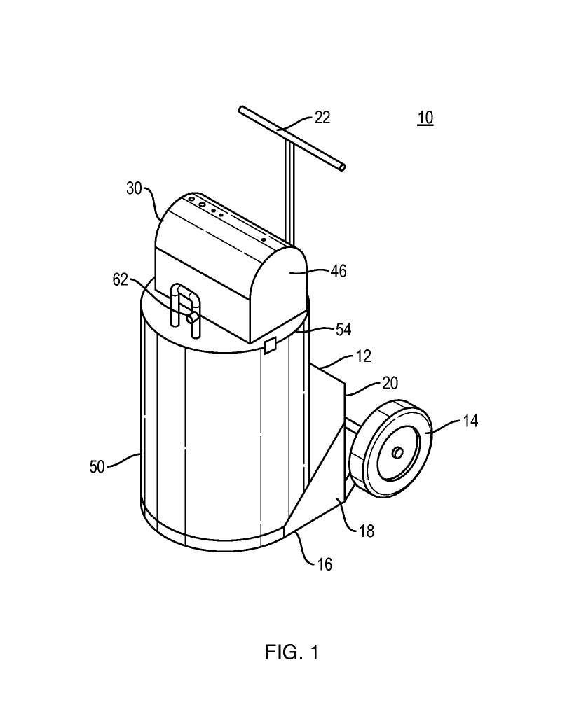

The present invention features a vacuum filtration device 10, FIG. 1, which removes sediment, food particles, and other impurities from oil. The vacuum filtration device 10 is specifically designed to be used with cooking oils and to filter the cooking oils in order to allow the cooking oils to be reused. FIG. 1 details the vacuum filtration device 10 according to the present invention, shown in combination with a mobile cart 12 that allows the device to be moved close to a deep fryer during use and moved away for storage when not in use.

The mobile cart 12 preferably features two or more wheels 14, a base member 16, a side member 18 and a back member 20. The mobile cart 12 is preferably stainless steel, however this is not intended to be a limitation of the current invention. The wheels 14 may be detachable from the mobile cart 12 via cotter pins (not shown) or any similar or equivalent device that will allow the wheels to be detached from the cart. The wheels 14 may feature a locking mechanism (not shown) to prevent the wheels 14 from moving. The mobile cart 12 may also feature a handle 22. The handle 22 may be removable via a retaining pin or other similar attachment device (not shown) that is configured to attach the handle 22 to the back member 20 and allows the handle 22 to be removed and reattached. In an alternate embodiment, the handle 22 may be fixably coupled to the back member 20 of the mobile cart 12. The handle 22 may feature a T shape as shown in FIG. 1. Other mobile cart configurations are contemplated and within the scope of the current invention.

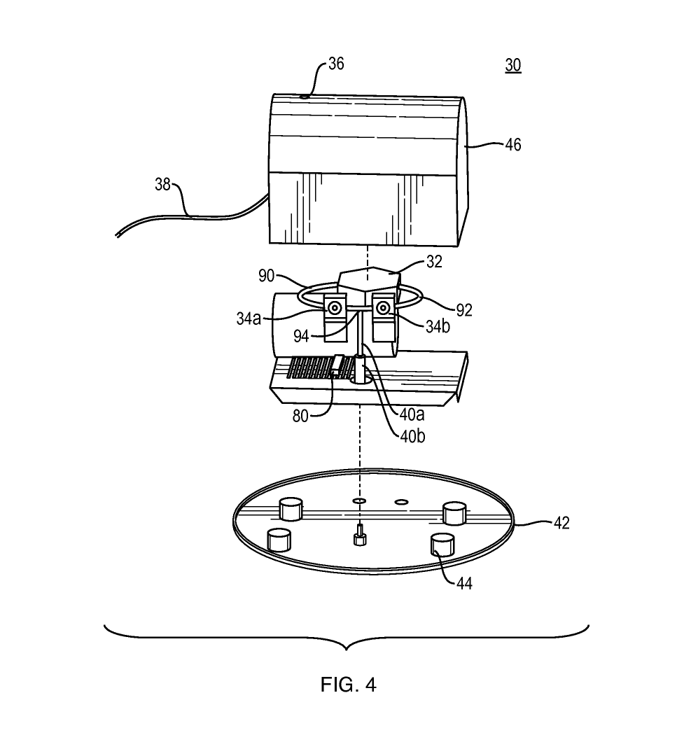

The vacuum filtration device 10 features a power unit 30, FIGS. 1 and 4, mounted on the exterior of a filtration device canister or container body 50. The power unit 30 is removable from the vacuum filtration device 10. The power unit 30 features an external housing 46 that includes a base 42, which may include one or more rubber feet 44. The housing is preferably stainless steel. The power unit 30 preferably includes a vacuum pump 32, one or more solenoid control valves 34, a switch 36, a power cord 38 and a quick disconnect 40 to the canister 50. The internal connections of the power unit 30 are preferably made with stainless steel tubing and threaded compression fittings. The vacuum port outlet 90 of the vacuum pump 32 is connected to the vacuum solenoid valve 34A. The pressure port outlet 92 of the vacuum pump 32 is connected to the pressure solenoid valve 34B. The two valves 34A/34B are joined together by a tee fitting 94 at which there is a female quick disconnect fitting 40A. The female quick disconnect fitting 40A attaches to the container lid 54 at the male quick disconnect fitting 40B, thereby anchoring the power unit 30 to the canister 50. The switch 36 is preferably a lighted switch, which is also reversible or bi-directional. The switch serves to turn the vacuum filtration device 10 on and off. The power cord 38 connects the vacuum filtration device 10 to an electrical outlet. Alternatively, the vacuum filtration device could be run utilizing battery power.

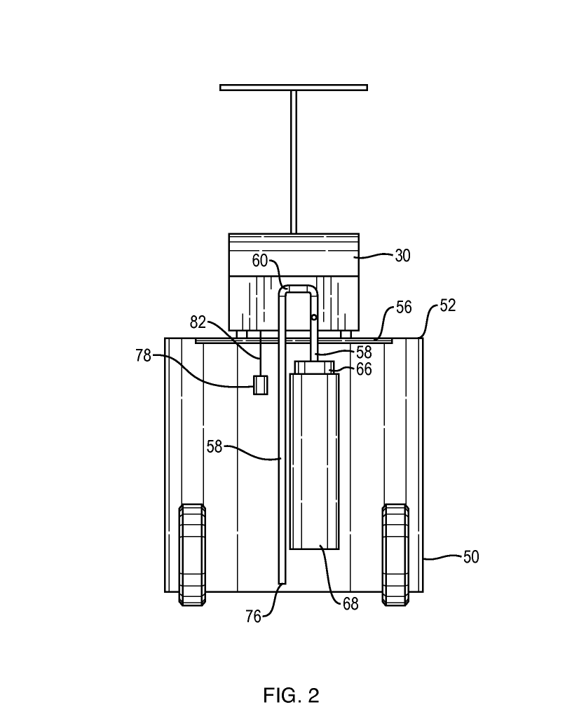

The container body canister 50 is preferably stainless steel and features a lid 52, FIG. 2. The canister 50 is sized to contain an appropriate amount of oil for the size cooking appliance from which the oil is being drained and filtered. The lid 52 preferably includes a locking mechanism 54, which securely locks the lid 52 to the canister 50. The locking mechanism 54 may be a ring clamp or toggle latch. Directly beneath the lid 52 may be a gasket 56. The gasket 56 may be a Viton® or other similar gasket.

A tube or pipe 58 is at least partially located within the canister 50. The tube or pipe 58 preferably extends from the bottom of the canister 50 and exits the canister 50 through an opening 60 in the lid 52. One end of the tube features a pick-up opening 76.

The tube or pipe 58 may include one or more fittings or connections 60 and a valve 62 that are external to the canister 50. The valve 62 is preferably a three way valve, which is configured to couple to the pipe 58 and a hose and nozzle assembly 70. The valve 62 is preferably stainless steel. The pipe 58 is preferably nickel plated cast iron and the fittings and connections 60 are preferably stainless steel. The pipe 58 extends back into the canister 50 and is coupled to an adapter head or lid 66, which is then coupled to a filtering mechanism or filter 68. The adapter head 66 is threaded onto the pipe 58 under the lid 52. The adapter head 66 and filter 68 are located within the canister 50. The filter 68 is preferably a polyester micron rated liquid filter media.

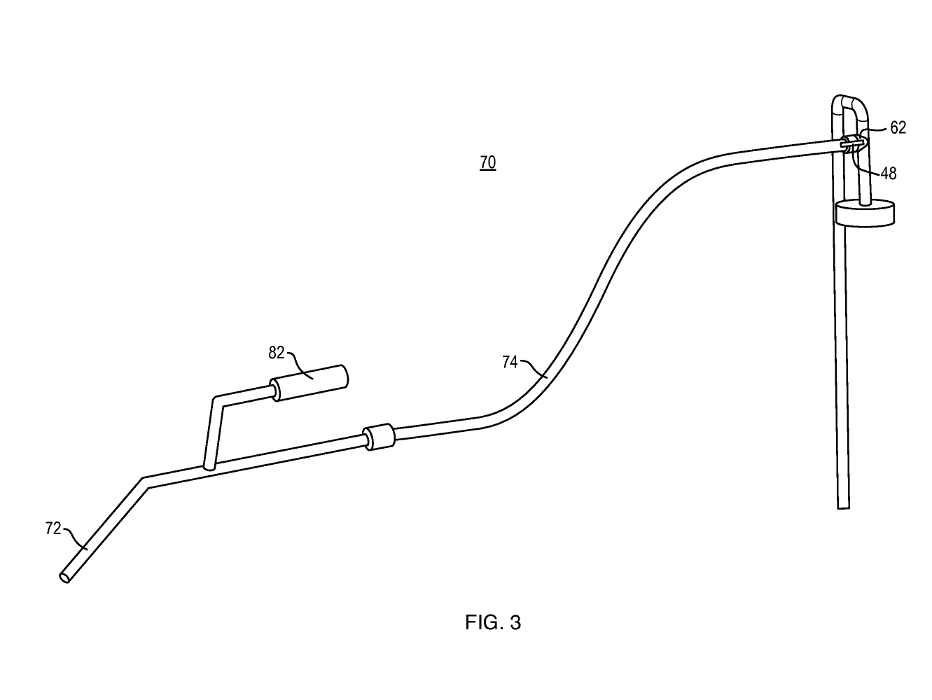

The hose and nozzle assembly 70, FIG. 3, features a hose 74, which is connected to the valve 62 at one end and a nozzle 72, which is connected to the opposite end of the hose 74. The nozzle 72 is configured to be placed into a fryer. The hose and nozzle assembly 70 further features attachment means 48, which may be a quick disconnect attachment means. The attachment means 48 are configured to securably couple the hose and nozzle assembly 70 to the valve 62. The hose and nozzle assembly 70 preferably include nickel plated fittings, a hose 74 that is an NSF/UL approved transfer hose and a nozzle 72 that is nickel plated and features a handle 82.

The oil in a deep fryer is contaminated by sediment during the frying operation. The vacuum filtration device 10 allows hot contaminated oil from a deep fryer to be vacuumed out, filtered and returned to the fryer. In use, the vacuum filtration device 10 is moved to a location proximate the deep fryer to be serviced. A filter powder or compound may be added to the hot oil in the fryer. The amount and type of filter powder or compound depends on the volume of oil being filtered, the contamination level of the oil and other factors. The filter powder or compound aids in the filtration process by reducing the particle size of the filter however, a powder or compound is not required for the vacuum filtration device 10 to function properly.

The nozzle 72 of the hose and nozzle assembly 70 is inserted directly into the hot oil of the deep fryer. The valve 62 is set to a mode that is configured to allow for the oil to be removed from the deep fryer (may be labeled “oil remove”). Turning the power unit bidirectional switch 36 to “OIL REMOVE” activates the vacuum pump 32 to create vacuum or negative pressure inside the canister 50, thereby drawing the hot oil up in the nozzle 72, through the hose 74, through the adapter head 66 and into the filter 68 inside the container 50. The filter 68 traps the sediment and impurities in the oil. The oil passes through the filter 68 and collects in the bottom of the canister 50. After all of the oil has been removed from the fryer, the vacuum formed in the canister 50 is relieved because the nozzle 72 is exposed to the atmosphere. The power unit 30 is then turned off via the switch 36.

The fryer should then be thoroughly cleaned. Once the fryer is emptied and cleaned, the filtered oil is ready to be returned to the fryer. The valve 62 is then switched to a mode that is configured to allow for the oil to be returned to the deep fryer (may be labeled “oil return”). Turning the power unit bidirectional switch 36 to “OIL RETURN” activates the vacuum pump 32 to create positive pressure inside the canister 50, thereby forcing the clean filtered oil up the tube 58 and through the pick-up opening 76. The filtered oil then travels through the valve 62, through the hose and nozzle assembly 70 and into the fryer. Once all of the filtered oil has been returned to the fryer, the power unit 30 can again be switched off via the switch 36.

An automatic float switch 78 is located in the canister 50. The automatic float switch 78 will turn off power to the vacuum pump 32 and all flow will cease in the event that the canister 50 is filled. The automatic float switch 78 is located inside the canister 50 at the high oil mark. The automatic float switch 78 is configured to attach to latching relays 80 located in the power unit housing 46 via a connection element 82.

The vacuum filtration device 10 can be easily moved from one location to the next safely without spillage and without contact with the hot oil because the device is a closed system. The filter 68 is easily cleaned by releasing the locking mechanism 54 and removing the lid 52. The sediment can be dumped from the filter 68 and the filter 68 may be washed by conventional means.

Accordingly, what is provided is a vacuum filtering operation that safely removes sediment from contaminated or used oil and delivers clarified oil ready for reuse in the food industry. The use of the device affords substantial savings in the expense of edible oils in the food industry.

Modifications and substitutions by one of ordinary skill in the art are considered to be within the scope of the present invention, which is not to be limited except by the allowed claims and their legal equivalents.

The invention claimed is:

1. A vacuum filtration device for cleaning used cooking oil from a cooking device, comprising:
a canister;
a pipe, wherein the pipe is at least partially disposed within the canister;
a valve, wherein the valve is coupled to the pipe at a location outside of the canister, and operable in one of a first and second position and configured in said first position to allow used cooking oil to flow into said canister and configured in said second position to allow used cooking oil to flow out of said canister;
a hose and nozzle assembly, coupled to the valve; and
a power unit, coupled to the canister, and configured to supply power to the vacuum filtration device and to control the valve, wherein the power unit is configured, in a first mode, to create a vacuum within the canister causing said used cooking oil to be drawn from a cooking device via the hose and nozzle assembly and through the valve disposed in a first position and into the pipe, thereby depositing said oil into the canister after said oil is passed through a filter located within the canister, and wherein said power unit is configured, in a second mode, to create a pressure in said canister and move said valve from said first position to a second position, causing said filtered, used cooking oil to be pushed from said canister via the pipe and through the valve and into the hose and nozzle assembly, thereby returning said filtered used cooking oil into the cooking device.

2. The vacuum filtration device of claim 1, wherein said vacuum filtration device is configured to sit at least partially on a mobile cart, wherein said mobile cart has two or more wheels configured for moving said mobile cart.

3. The vacuum filtration device of claim 1, wherein internal connections of the power unit are made with stainless steel tubing and threaded compression fittings.

4. The vacuum filtration device of claim 1, wherein said power unit is configured to operate with a switch, wherein said switch is bi-directional, wherein said switch is configured to turn the filtration device on and off.

5. The vacuum filtration device of claim 1, wherein the canister is stainless steel.

6. The vacuum filtration device of claim 1, wherein the canister includes a top region configured for receiving a lid, and wherein said lid includes a locking mechanism, configured to securely lock the lid to the top region of said canister.

7. The vacuum filtration device of claim 1, wherein the valve is a two way stainless steel valve.

8. The vacuum filtration device of claim 1, wherein said filter is a polyester micron rated liquid filter media.

9. The vacuum filtration device of claim 1, further comprising an automatic float switch located in the canister, said automatic float switch configured to turn off power to the vacuum pump when the canister is filled to a predetermined level.

10. A filtration device for cleaning used cooking oil, said filtration device comprising:
a canister;
a first tube, located at least partially within the canister, said first tube having a first end with a pick-up opening, wherein said first tube extends from the pick-up opening proximate a bottom portion of the canister and exits the canister through an opening in a lid on said canister;
a valve, said valve coupled to a second end of said first tube, a hose and nozzle assembly, and to a first end of a second tube, said second tube extending into said canister;
a filtering mechanism, coupled to a second end of said second tube, said filtering mechanism located within said canister and configured to filter used cooking oil entering said canister; and
a power unit, mounted to said canister, said power unit comprising: a pump having a switch, a quick disconnect to said canister, and a vacuum port outlet, wherein said power unit is configured to draw said used cooking oil through said hose and nozzle assembly and down said second tube through said filtering mechanism in a first mode, and to force filtered cooking oil up said first tube through said pick-up opening and back through said hose and nozzle assembly in a second mode.

11. The filtration device of claim 10, wherein the switch is bi-directional, wherein said switch is configured to turn the filtration device on and off.

12. The filtration device of claim 10, wherein the canister is stainless steel.

13. The filtration device of claim 10, wherein the canister includes a lid, wherein said lid includes a locking mechanism, which securely locks the lid to the canister.

14. The filtration device of claim 10, wherein the valve is a three way stainless steel valve.

15. The filtration device of claim 10, wherein said filtering mechanism includes a filter element, wherein said filter element is a polyester micron rated liquid filter media.

16. The filtration device of claim 10, wherein said hose and nozzle assembly comprises a hose, which is fixably coupled to said valve, and a nozzle, which is configured to be placed into a fryer.

17. The filtration device of claim 10, further comprising an automatic float switch located in the canister, said automatic float switch configured to turn off power to the vacuum pump in the event that the canister is filled to a predetermined level.

18. The filtration device of claim 10, wherein said filtration device is configured to sit at least partially on a mobile cart, wherein said mobile cart has two or more wheels configured for moving said mobile cart.

19. The filtration device of claim 10, wherein internal connections of the power unit are made with stainless steel tubing and threaded compression fittings.

20. A method of cleaning used cooking oil, wherein said method includes the following acts:
using a vacuum filtration device comprising a canister coupled to a power unit with a vacuum pump;
switching a switch in a first direction, which activates said vacuum pump to create negative pressure within said canister;
said negative pressure drawing used cooking oil from a cooking device with a hose and nozzle assembly, said hose and nozzle assembly coupled to a filter located inside said canister;
filtering said used cooking oil by passing said used cooking oil through said filter, thereby creating clean filtered cooking oil;
allowing said clean filtered cooking oil to flow into a bottom portion of said canister;
switching said switch to a second direction which activates said vacuum pump to create positive pressure within said canister;
said positive pressure causing said clean filtered cooking oil through said hose and nozzle assembly, thereby returning said clean filtered cooking oil to said fryer through said hose and nozzle assembly.
